(19) United States
(12) Patent Application Publication
(10) Pub. No.: US 2012/0242179 A1
(43) Pub. Date: Sep. 27, 2012

(54) DRIVE UNIT WIRING SYSTEM

(75) Inventor: Andreas Sylvester Giessner, Friedrichshafen (DE)

(73) Assignee: ZF FRIEDRICHSHAFEN AG, Friedrichshafen (DE)

(21) Appl. No.: 13/513,619

(22) PCT Filed: Nov. 3, 2010
(86) PCT No.: PCT/EP2010/066681

§ 371 Date: Jun. 4, 2012

(30) Foreign Application Priority Data
Dec. 10, 2009 (DE) 10 2009 054 469.0

(51) Int. Cl. H02K 11/00

(52) U.S. Cl. 310/71

(57) ABSTRACT

A drive unit wiring system for a motor vehicle, whose drive unit comprises an electric machine. The electric machine is wired with high-voltage wiring (3) and with low-voltage wiring (4) in such a manner that when a safety plug connection (6) of the low-voltage wiring (4) is disconnected, the high-voltage wiring (3) can be disconnected and connected without voltage. A cable holder (7) guides the high-voltage wiring (3) and is positioned relative to the plug connection (5) of the high-voltage wiring (3) in such a manner that the plug connection can only be disconnected when the cable holder (7) is open. The safety plug connection (6) is integrated in the cable holder (7) such that either the cable holder (7) can only be opened when the safety plug connection (6) is disconnected, or the safety plug connection (6) can be automatically disconnected when the cable holder (7) is opened.

This application is a National Stage completion of PCT/EP2010/066681 filed Nov. 3, 2010, which claims priority from German patent application serial no. 10 2009 054 469.0 filed Dec. 10, 2009.

### FIELD OF THE INVENTION

The invention concerns a drive unit wiring system for a motor vehicle whose drive unit comprises at least one electric machine.

### BACKGROUND OF THE INVENTION

The main components of a motor vehicle's drive-train are a drive unit and a transmission. The transmission converts rotational speeds and torques, and so transmits the traction force provided by the drive unit to a drive output of the drive-train. The present invention concerns a drive unit wiring system for a motor vehicle which, as its drive unit, has either a purely electric drive or a hybrid drive, a hybrid drive comprising an internal combustion engine and an electric machine whereas a purely electric drive has no internal combustion engine but comprises exclusively an electric machine.

In motor vehicles known from the prior art, the electric machine of the drive unit in the form of an electric drive or a hybrid drive, is wired on the one hand with high-voltage wiring and on the other hand with low-voltage wiring. Associated with the low-voltage wiring is a safety plug connection, such that when the safety plug connection of the low-voltage wiring is disconnected the high-voltage wiring is de-energized, so that a plug connection of the high-voltage wiring can be disconnected and connected without voltage.

The safety plug connection of the low-voltage wiring is also called the HV-Interlock (High Voltage Interlock) or the pilot contact or pilot line.

In motor vehicles or drive unit wiring systems known from the prior art this safety plug connection is made as a separate assembly. Thus, there is a risk that the plug connection of the high-voltage wiring may be disconnected or connected by a person working on the drive unit even when the high-voltage wiring is still under voltage. From the standpoint of safety this is a disadvantage. A further disadvantage of drive unit wiring systems known from the prior art is that during operation the high-voltage wiring in particular is excited into vibrations, whereby it can be damaged.

### SUMMARY OF THE INVENTION

Starting from there the present invention addresses the problem of providing a new type of drive unit wiring system.

According to the invention, the high-voltage wiring is guided by a cable holder, the cable holder being positioned relative to the plug connection of the high-voltage wiring in such manner that the plug connection can only be disconnected when the cable holder is open, and such that the safety plug connection is integrated in the cable holder in such manner that either the cable holder can only be opened when the safety plug connection is disconnected, or when opening the cable holder the safety plug connection can be disconnected automatically.

With the drive unit wiring according to the invention there is no risk that the high-voltage wiring will be damaged as a result of vibrations, since the cable holder guides the high-voltage wiring and holds it fast.

Furthermore, since the cable holder is positioned relative to the plug connection of the high-voltage wiring in such manner that the plug connection can only be disconnected when the cable holder is open, and in addition the safety plug connection of the low-voltage wiring is integrated in the cable holder in such manner that either the cable holder can only be opened when the safety plug connection is disconnected, or when opening the cable holder the safety plug connection is disconnected automatically, there is also no risk that the plug connection of the high-voltage wiring will be disconnected or connected while it is still under high voltage.

Accordingly, by virtue of the invention all the disadvantages of drive unit wiring systems known from the prior art are avoided.

### BRIEF DESCRIPTION OF THE DRAWINGS

Preferred further developments of the invention emerge and from the description below. An example embodiment of the invention, to which it is not limited, is described in more detail with reference to the drawings, which show:

FIG. 1: A section of a drive-train of a motor vehicle in the area of a drive unit wiring system according to the invention, viewed from above;

FIG. 2: A detail of the drive unit wiring system according to the invention, viewed from below; and

FIG. 3: The detail of FIG. 1 viewed from the side, partially sectioned along the section direction 3-3 in FIG. 2.

### DETAILED DESCRIPTION OF THE PREFERRED EMBODIMENTS

The present invention concerns a drive unit wiring system for a motor vehicle, which comprises at least one electric machine in the drive unit.

The electric machine of the drive unit which is to be wired in accordance with the drive unit wiring system according to the invention can be either part of a hybrid drive, or a purely electric drive.

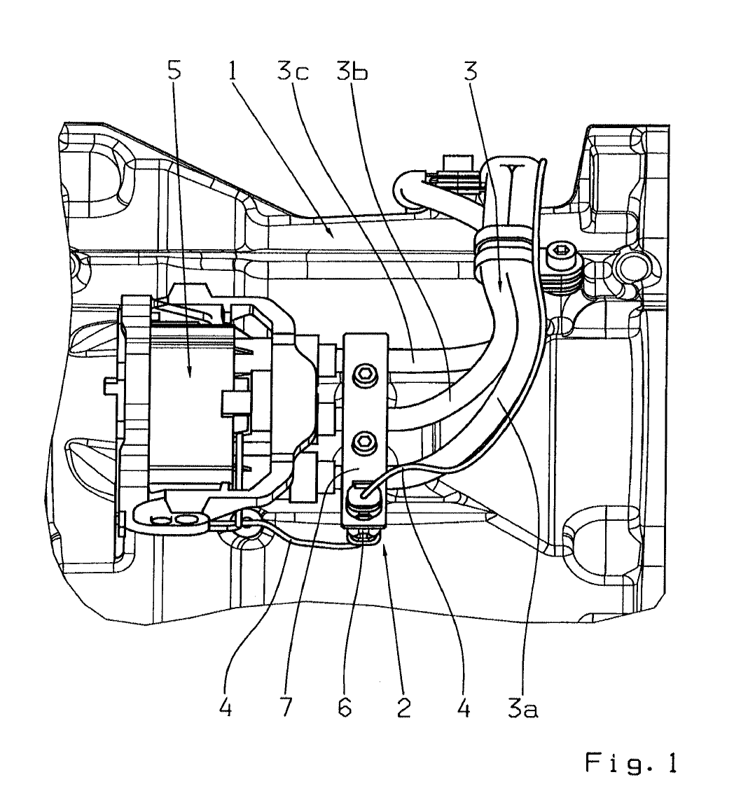

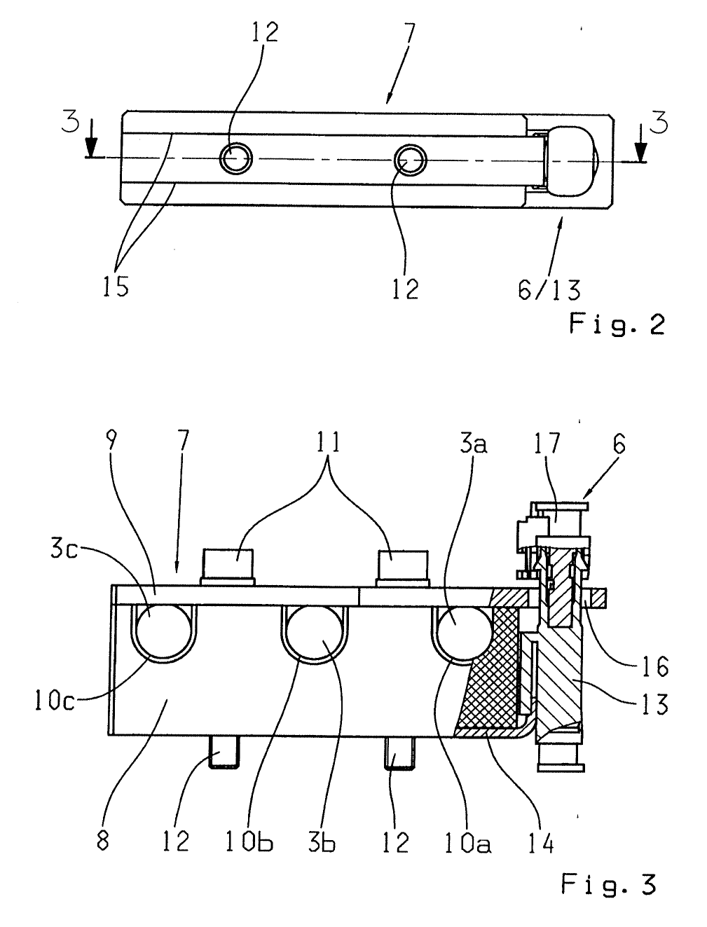

FIG. 1 shows a section of a drive-train of a motor vehicle that comprises a hybrid drive as its drive unit, namely in the area of a so-termed hybrid module 1 and a drive unit wiring system 2 according to the invention.

An electric machine of the drive unit (not shown in detail), which is integrated in the hybrid module 1, is wired on the one hand with high-voltage wiring 3 and on the other hand with low-voltage wiring 4, wherein three phase cables 3a, 3b and 3c of the high-voltage wiring 3 are shown, which contact the electric machine of the drive unit by way of a common plug connection 5. The high-voltage wiring 3 contacts the electric machine of the drive unit with an inverter or voltage converter (not shown in FIG. 1), and thus a power-electronic unit.

Associated with the low-voltage wiring 4 is a safety plug connection 6 which, when it is disconnected or open, de-energizes the high-voltage wiring 3, such that the low-voltage wiring 4 wires the electric machine of the drive unit either with the inverter or with some other control device. If the inverter or other control device detects that the safety plug connection 6 is open or disconnected, the high-voltage wiring 3 is switched to a voltage-free condition so that the plug connection 5 of the high-voltage wiring 3 can be disconnected and connected without voltage.

The drive unit wiring system according to the invention comprises a cable holder 7 which guides the high-voltage wiring 3, namely the phase cables 3a, 3b and 3c thereof, so that during operation there is no tendency for them to vibrate and they cannot therefore be damaged due to vibrations.

The cable holder 7 is positioned relative to the plug connection 5 of the high-voltage wiring 3 in such manner that the plug connection can only be disconnected when the cable holder 7 is open. Preferably, this is done by making the distance between the cable holder 7 and the plug connection 5 of the high-voltage wiring 3 smaller than the plug length of the plug connection 5 of the high-voltage wiring 3.

Furthermore, according to the invention the safety plug connection 6 of the low-voltage wiring 4 is integrated in the cable holder 7 in such manner that either the cable holder 7 can only be opened when the safety plug connection 6 is disconnected, or the safety plug connection 6 is automatically disconnected when opening the cable holder 7.

In the example embodiment illustrated, the cable holder 7 comprises a lower portion 8 and an upper portion 9. Through-going openings 10a, 10b and 10c are made in the lower portion 8 of the cable holder 7 for the phase cables 3a, 3b and 3c of the high-voltage wiring 3. In the example embodiment shown, the upper portion 9 of the cable holder 7 can be screwed to the lower portion 8 by means of fixing screws 11 in such manner that the fixing screws 11 pass through apertures in both the lower portion 8 and the upper portion 9, so that sections 12 of the fixing screws 11 having an external thread engage in apertures of the hybrid module 1 having an internal thread, such that when the upper portion 9 is screwed to the lower portion 8 of the cable holder 7, the cable holder 7 as a whole is screwed onto the hybrid module 1.

During this the upper portion 9 and the lower portion 8 of the cable holder 7 are pressed together so as to ensure secure fixing of the phase cables 3a, 3b and 3c of the high-voltage wiring 3 in the through-going openings 10a, 10b and 10c of the cable holder 7.

A first plug component 13 of the safety plug connection 6 is associated with the lower portion 8 of the cable holder 7. In the example embodiment illustrated in FIG. 3 the first plug component 13 of the safety plug connection 6 is connected firmly to the lower portion 8 of the cable holder 7 by means of a holding element 14 in the form of a bent sheet, and for this purpose the holding element 14 engages in a groove 15 formed on the underside of the lower portion 8. The holding element 14 has integrated detent means for the first plug component 13.

As shown in the example embodiment illustrated in FIG. 3, the first plug component 13, which is firmly connected to the lower portion 8 of the cable holder 7, extends through an aperture 16 of the upper portion 9 of the cable holder 7, such that in this condition a second plug component 17 of the safety plug connection 6 formed as a separate assembly is connected to the first plug component 13 thereof. Only when the second plug component 17 is separated from the first plug component 13 of the safety plug connection 6 so that the safety plug connection 6 is disconnected or open, can the upper portion 9 of the cable holder 7 be moved relative to its lower portion 8 in order to open the cable holder 7.

Accordingly, in the example embodiment shown, in order to open the cable holder 7 the safety plug connection 6 of the low-voltage wiring necessarily has to be disconnected, since if the second plug component 17 is coupled to the first plug component 13 of the safety plug connection 6 so that the safety plug connection 6 is closed, the upper portion 9 of the cable holder 7 cannot be moved relative to the lower portion 8 thereof. Thus, if the safety plug connection 6 is closed the cable holder 7 cannot be opened, so that the plug connection 5 of the high-voltage wiring 3 can then also not be actuated, namely it cannot be opened or closed.

As a difference from the example embodiment shown, it is also possible for the second plug component 17 to be associated with the upper portion 9 of the cable holder 7 in such manner that when the upper portion 9 of the cable holder 7 is moved relative to its lower portion 8, the safety plug connection 6 can be disconnected automatically. In this case the first plug component 13 is connected fixed to the lower portion 8 of the cable holder 7 and the second plug component 17 is connected fixed to the upper portion 9 of the cable holder 7.

Thus, the present invention proposes a drive unit wiring system for a motor vehicle, in whose cable holder 7 for the phase cables 3a, 3b and 3c of the high-voltage wiring 3 the safety plug connection 6 of the low-voltage wiring 4 is integrated. The phase cables 3a, 3b and 3c of the high-voltage wiring 3 can only be accessed when the safety plug connection 6 is disconnected or opened. Furthermore, since the distance of the cable holder 7 from the plug connection 5 of the high-voltage connection 5 is chosen such that the plug length of the plug connection 5 is larger than the distance between the cable holder 7 and the plug connection 5 of the high-voltage wiring 3, the plug connection 5 of the high-voltage wiring 3 can only be released or disconnected and connected when the cable holder 7 is open and accordingly when the safety plug connection 6 of the low-voltage wiring 4 is disconnected, so ensuring that the plug connection 5 of the high-voltage wiring 3 is always without voltage when accessed.

### Indexes

1 Hybrid module

2 Drive unit wiring system

3a, 3b, 3c Phase cables

4 Low-voltage wiring

5 Plug connection

6 Safety plug connection

7 Cable holder

8 Lower portion

9 Upper portion

10a, 10b, 10c Through-going openings

11 Fixing screws

12 Section

13 First plug component

14 Holding element

15 Groove

16 Recess

17 Second plug component

1-10. (canceled)

11. A drive unit wiring system for a motor vehicle comprising:
a drive unit comprising an electric machine,
the electric machine being wired with high-voltage wiring (3) and with low-voltage wiring (4) in such a manner that when a safety plug connection (6) of the low-voltage wiring (4) is disconnected, the high-voltage wiring (3) is disconnectable and connectable without voltage,
a cable holder (7) guiding the high-voltage wiring (3), and the cable holder (7) being positioned relative to a plug connection (5) of the high-voltage wiring (3) in such a manner that the plug connection only being disconnectable when the cable holder (7) is open, and such that the safety plug connection (6) being integrated in the cable holder (7) in such a manner that either the cable holder (7) is only openable when the safety plug connection (6) is disconnected or the safety plug connection (6) being automatically disconnected when the cable holder (7) is opened.

12. The drive unit wiring system according to claim 11, wherein a distance between the cable holder (7) and the plug connection (5), of the high-voltage wiring (3), is smaller than a plug length of the plug connection (5), of the high-voltage wiring (3).

13. The drive unit wiring system according to claim 11, wherein the cable holder (7) comprises a lower portion (8) and an upper portion (9), and a first plug component (13), of the safety plug connection (6), is associated with the lower portion (8) of the cable holder and a second plug component (17), of the safety plug connection (6), is associated with the upper portion (9) of the cable holder in such a manner that the safety plug connection (6) is automatically disconnected when the upper portion is moved relative to the lower portion to open the cable holder (7).

14. The drive unit wiring system according to claim 13, wherein the first plug component (13) of the safety plug connection (6) is fixedly connected to the lower portion (8) of the cable holder (7) and the second plug component (17) of the safety plug connection (6) is fixedly connected to the upper portion (9) of the cable holder (7).

15. The drive unit wiring system according to claim 11, wherein the cable holder (7) comprises a lower portion (8) and an upper portion (9), and a first plug component (13), of the safety plug connection (6), is associated with the lower portion (8) of the cable holder (7), and the upper portion (9) of the cable holder (7) can only be moved relative to the lower portion (8), for opening the cable holder (7), if a second plug component (17), of the safety plug connection (6), is separated from the first plug component (13).

16. The drive unit wiring system according to claim 15, wherein the first plug component (13), of the safety plug connection (6), is connected fixed to the lower portion (8) of the cable holder (7) and extends through the upper portion thereof in such a manner that the second component (17), of the safety plug connection (6), and the first plug component (13) are only connected when the cable holder (7) is closed.

17. The drive unit wiring system according to claim 11, wherein the electric machine is connected to a voltage converter by the high-voltage wiring (3).

18. The drive unit wiring system according to claim 11, wherein the electric machine is connected to either a voltage converter or a control device via the low-voltage wiring (4).

19. The drive unit wiring system according to claim 11, wherein the electric machine is part of a purely electric drive.

20. The drive unit wiring system according to claim 11, wherein the electric machine is part of a hybrid drive.

21. A drive unit wiring system for a motor vehicle comprising:
a drive unit comprising an electric machine,
the drive unit wiring system comprising both high-voltage wiring and low-voltage wiring wired to the electric machine such that when a safety plug connection of the low-voltage wiring is disconnected, voltage in the high-voltage wiring is shut off;
a cable holder guiding the high-voltage wiring and being positioned relative to the plug connection of the high-voltage wiring such that the plug connection of the high-voltage wiring is only disconnectable when the cable holder is open; and
the safety plug connection is integrated in the cable holder such that either the cable holder can only be opened when the safety plug connection is disconnected or the safety plug connection is automatically disconnected when the cable holder is opened.

22. The drive unit wiring system according to claim 21, wherein a distance between the cable holder and the plug connection, of the high-voltage wiring, is smaller than a plug length of the plug connection, of the high-voltage wiring.

23. The drive unit wiring system according to claim 21, wherein the cable holder comprises a lower portion and an upper portion, and a first plug component, of the safety plug connection, is associated with the lower portion of the cable holder and a second plug component, of the safety plug connection, is associated with the upper portion (9) of the cable holder in such a manner that the safety plug connection is automatically disconnected when the upper portion is moved relative to the lower portion to open the cable holder.

24. The drive unit wiring system according to claim 23, wherein the first plug component of the safety plug connection is fixedly connected to the lower portion of the cable holder and the second plug component of the safety plug connection is fixedly connected to the upper portion of the cable holder.

25. The drive unit wiring system according to claim 21, wherein the cable holder comprises a lower portion and an upper portion, and a first plug component, of the safety plug connection, is associated with the lower portion of the cable holder, and the upper portion of the cable holder can only be moved relative to the lower portion, for opening the cable holder, if a second plug component, of the safety plug connection, is separated from the first plug component.

26. The drive unit wiring system according to claim 25, wherein the first plug component, of the safety plug connection, is connected fixed to the lower portion of the cable holder and extends through the upper portion thereof in such a manner that the second component, of the safety plug connection, and the first plug component are only connected when the cable holder is closed.

27. The drive unit wiring system according to claim 21, wherein the electric machine is connected to a voltage converter by the high-voltage wiring.

28. The drive unit wiring system according to claim 21, wherein the electric machine is connected to either a voltage converter or a control device via the low-voltage wiring.

29. The drive unit wiring system according to claim 21, wherein the electric machine is part of a purely electric drive.

30. The drive unit wiring system according to claim 21, wherein the electric machine is part of a hybrid drive.
